(19) United States
(12) Patent Application Publication
(10) Pub. No.: US 2009/0185069 A1
(43) Pub. Date: Jul. 23, 2009

(54) IMAGING APPARATUS AND CONTROL METHOD THEREOF

(75) Inventor: Keisuke Aoyama, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/353,668

(22) Filed: Jan. 14, 2009

(30) Foreign Application Priority Data
Jan. 22, 2008 (JP) 2008-011629

(51) Int. Cl. H04N 5/232

(52) U.S. Cl. 348/346; 348/E05.045

(57) ABSTRACT

An imaging apparatus prohibits recording of an image in a recording medium according to an operation of a second switch while a first auto-focusing operation is performed based on a phase difference of an object image, and permits recording of the image in the recording medium according to an operation of a second switch while a second auto-focusing operation is performed based on a high frequency component of a signal from a sensor which photoelectrically converts the object image.

### BACKGROUND OF THE INVENTION

1. Field of the Invention

The present invention relates to an imaging apparatus such as a digital single-lens reflex camera having a live view function by which an image can be confirmed prior to a photographing of the image.

2. Description of the Related Art

In an imaging apparatus such as a digital single-lens reflex camera, a portion of light beam from an imaging lens is partially reflected by a main mirror (light path division system) configured of a half-mirror that leads the portion of the light beam to a finder optical system, thereby enabling an optical view of a subject (object). Further, the light beam transmitting through the half-mirror is reflected by a sub-mirror placed behind the half-mirror to be led to a focus detection unit. The focus detection unit detects a focusing state of the imaging lens by using a focus detection system such as a phase difference detection system, and performs an auto-focus operation (AF operation) in which the imaging lens is driven to an in-focus position based on the detection result. In the AF operation of the phase difference system, the imaging lens can be moved to the in-focus position with the minimum number of times in driving the imaging lens because a defocus amount (a shifting amount from an in-focus position) and a direction of the in-focus position can be known.

Thus, in a single-lens reflex camera, the light beam from the imaging lens is led to a finder by a main mirror and to the focus detection unit by the sub-mirror, respectively. Further, an image light beam is led to an image sensor by retracting the main mirror and the sub-mirror from a light path of the imaging lens when taking pictures.

Recently, a single-lens reflex type digital camera is discussed in which a continuous shooting can be performed while a mirror is retracted from the photographing light path and a dynamic live view image is displayed on an external monitor. In such a configuration, Japanese Patent Application Laid-Open No. 2005-20397 discusses a digital camera in which a mirror is repositioned at a reflection position (within a light path of an imaging lens) to perform an AF operation of a phase difference system when an AF button is pressed while the digital camera is in a live view state. More specifically, the digital camera discussed in the Japanese Patent Application performs focus detection and controls the imaging lens. In addition, the digital camera automatically returns to the live view state after the imaging lens is controlled to be moved to an in-focus position to enable a release operation even while the AF button is continuously pressed.

Still further, as an AF system of a digital camera, there is a contrast system in which a focus detection and a lens control are performed based on a contrast between image signals obtained from an image sensor. In an AF operation of the contrast system, a focus position of a photographic lens is moved among a position as it is, a front focus position, and a rear focus position, to perform a comparison of a contrast between AF areas within images. According to a result of the comparison, the photographic lens is driven to a position where the contrast is larger. By repeating the above operation, the photographic lens is adjusted to a position where the contrast is the largest. In the AF operation of the contrast system, the focus detection can be performed while keeping the live view state. Japanese Patent Application Laid-Open No. 2001-272593 discusses a digital camera technique in which the AF operation of the contrast system can be performed depending on the situation

However, the single-lens reflex type digital camera, in which a focus adjustment can be performed by a plurality of AF systems while the digital camera is in the live view state, has the following problems.

Each of the two AF systems performed while the digital camera is in the live view state has advantages and disadvantages, respectively. One system requires entering of the main mirror into the photographing light path while the other does not requires that processing. It is desired to perform a control suitable for the individual auto-focus operation by overcoming the above-described difference.

### SUMMARY OF THE INVENTION

The present invention is directed to, in a case where there are an auto-focus system in which a live view state is once stopped and an auto-focus system in which a live view state is not stopped, a technique to allow a digital camera to take a picture by performing control suitable for each of the auto-focus systems.

According to an aspect of the present invention, an imaging apparatus includes a monitor configured to display an image generated based on a signal from a sensor which photoelectrically converts an object image, a first auto-focus unit configured to perform a first auto-focusing operation based on a phase difference of the object image according to an operation of a first switch by a user, a light path switching unit configured to lead light having passed through an imaging optical system to the first auto-focusing unit, a live view controller configured to retract the light path switching unit from a light path of the imaging optical system to the sensor, and display an image from the sensor on the monitor, a second auto-focus unit configured to perform a second auto-focusing operation based on a high-frequency component of the signal from the sensor in response to an operation of the first switch by the user, a second switch configured to record the image from the sensor in a recording medium, and an image recording controller configured to prohibit recording of the image in the recording medium according to the operation of the second switch while the first auto-focusing operation is performed, and permits recording of the image in the recording medium according to the operation of the second switch while the second auto-focusing operation is performed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a perspective view illustrating a digital camera according to an exemplary embodiment of the present invention.

FIG. 2 is a view illustrating an optical arrangement of the digital camera according to the exemplary embodiment of the present invention.

FIG. 3 is a block diagram illustrating a circuit configuration of the digital camera according to the exemplary embodiment of the present invention.

FIG. 4 is a transition diagram illustrating a change of a state of the digital camera according to exemplary embodiment of the present invention.

FIG. 5 is a view illustrating an AF system setting while the digital camera according to the exemplary embodiment of the present invention is providing a live view.

FIGS. 6A and 6B are flow charts, respectively, illustrating a live view operation of the digital camera according to the exemplary embodiment of the present invention.

FIG. 7 is a flow chart illustrating a release operation of the digital camera according to the exemplary embodiment of the present invention.

### DETAILED DESCRIPTION OF THE EMBODIMENTS

Various exemplary embodiments, features, and aspects of the invention will be described in detail below with reference to the drawings.

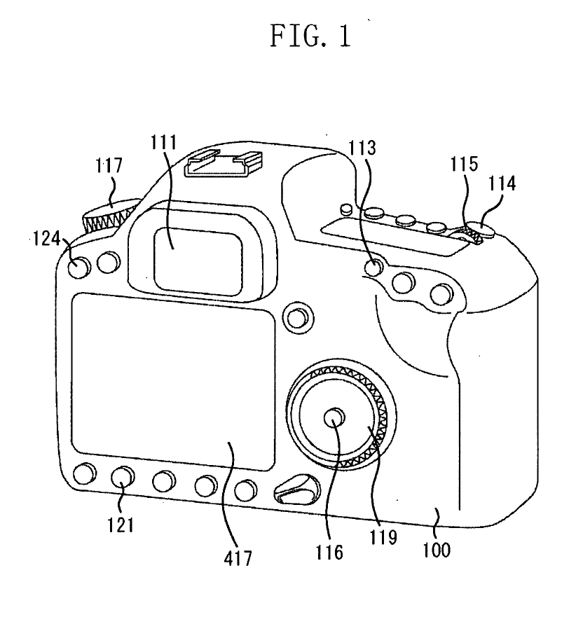

FIG. 1 is a perspective view illustrating an outer appearance of a digital camera as an imaging apparatus according to an exemplary embodiment of the present invention.

In FIG. 1, an eyepiece window 111 for finder viewing, a release button 114, an electronic dial 115, and a photographing mode dial 117 are provided on an upper portion of a camera main body 100.

When a main mirror 20 which will be described below, is in its down position (within a light path of an imaging optical system 19 of an imaging lens as described below), a subject can be viewed through the eyepiece window 111. The release button 114 is electrically coupled to a switch SW1 which is locked ON while it is half-pressed and a switch SW2 which is locked ON while it is fully pressed. A full-press of the release button 114 enables a user to record (store) an image. The electronic dial 115 is a multi-functional signal input member for inputting numerical values into the camera or switching an operation mode between various operation modes in combination with the other operation buttons.

A rear surface of the camera main body 100 is provided with a monitor unit 417 such as a liquid crystal display (LCD) which displays a photographed image, various setting screens, a live view image, and the like, and a monitor button 121 for performing an ON/OFF action of the monitor unit 417. The rear surface of the camera main body 100 is further provided with an electronic sub-dial 119, a SET button 116, a menu button 124, an AF button 113, and the like.

The AF button 113 is a switch for activating an auto-focusing operation from a live view state. The AF button 113 activates a focus detection unit 413 operating according to a phase difference system and drives an imaging optical system 19 of an imaging lens 18 based on the result of the focus detection (focus signal), when an AF system during the LV (live view) is set to the phase difference system. Further, when the AF operation of a contrast system is set, a photographic lens 18 is moved and contrast values output from an image processing unit 425 are compared to each other. Accordingly, the contrast becomes larger, and a position where the contrast finally reaches the maximum contrast value is determined as an in-focus point. A focus adjustment is performed in this manner.

In the present digital camera, two AF systems activated from the live view state are exclusive and the digital camera performs an auto-focus operation by an AF system set by one button in advance. Therefore, an erroneous pressing of a switch or an unnecessary confusion can be eliminated.

In photographing with an optical finder, the AF operation of the phase difference system is operated when the release button is half pressed. However, in a live view state, the auto-focusing is started by the AF button 113 in order to separate a release operation from an auto-focusing operation. In the case where the AF system during the LV is set to the phase difference system, it is not convenient that a live view display is automatically finished immediately before the release operation. Further, in the case of the contrast system, it takes time before determining the in-focus point and therefore, a photographer may miss the timing to take a picture. Further, in the case of the AF operation of the contrast system, since the in-focus position is detected based on a comparison of contrasts obtained by moving a lens, the lens needs to be driven even when the lens is placed at the in-focus position beforehand.

The menu button 124 allows the monitor unit 417 to display a menu screen for various setting of the camera. In the menu screen, a list of setting items is displayed. The photographer selects a setting item by using the electronic sub-dial 119 to press the SET button 116 at a position of the setting item the photographer desires. Accordingly, a set screen indicated by the setting item is displayed. A method of setting the AF system during the LV from the menu screen will be described below.

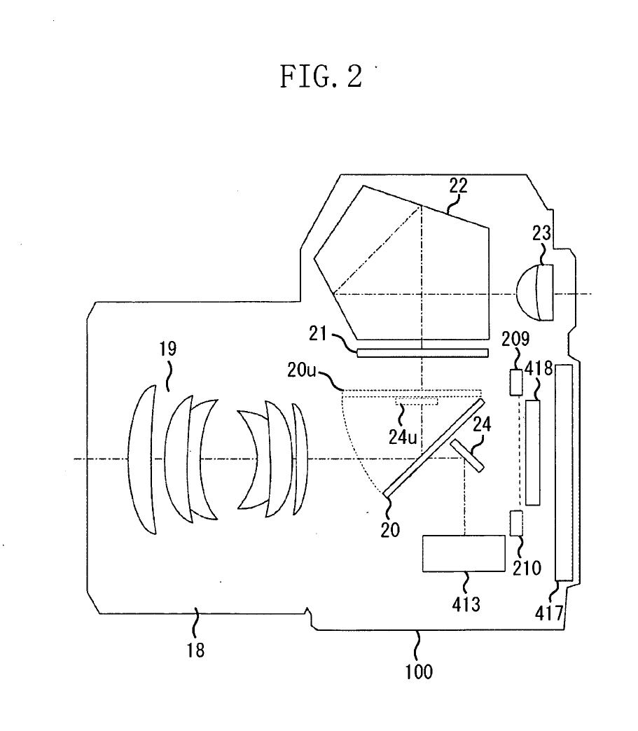

FIG. 2 is a view illustrating an optical arrangement of the above described digital camera.

In FIG. 2, a camera main body 100 includes an imaging lens 18 including the imaging optical system 19 and a diaphragm. A focus detection unit 413 includes focus detection systems (an optical system and a focus detection sensor). In the focus detection unit 413, light beam, which passed through different exit pupil areas formed by the imaging optical system 19 from a subject, is secondary-image-formed and a relative position displacement amount of thus obtained paired images is calculated, so that a defocus amount of the subject is detected (AF operation of the phase difference system).

The main mirror 20 which is provided with a half-mirror divides the light beam from the subject into a direction of the sub-mirror 24 and a direction of an optical finder. The sub-mirror 24 held by the main mirror 20 leads the light beam from the subject to the focus detection unit 413. When the main mirror 20 and the sub-mirror 24 are in their down positions, respectively, the focus detection unit 413 can perform focus detection. The optical finder comprises a focus plate 21, a penta-prism 22, and an eyepiece lens 23.

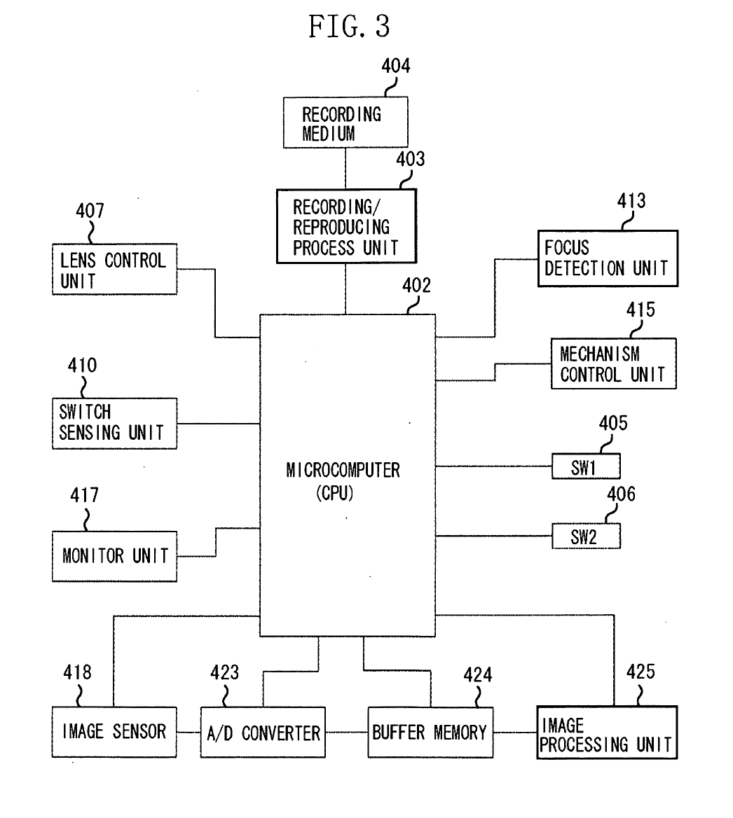

A second curtain 209 and a first curtain 210 constitute a shutter of the digital camera. The second curtain 209 is moved (light shielding state) after a predetermined time period has lapsed since the first curtain 210 is moved (open state). Accordingly, an exposure time is controlled. An image sensor 418 converts a photographed image into an electric signal for every pixel. The converted electric signal is processed by an analog-to-digital (A/D) converter 423 and an image processing unit 425 which are illustrated below with reference to FIG. 3, and recorded in a recording medium in the form of an image data. A monitor unit 417 displays the photographed image and various setting screens.

20u and 24u denote up-positions of each of the main mirror 20 and the sub-mirror 24 where the main mirror 20 and the sub-mirror 24 are retracted from the light path where light passes through the imaging optical system 19 or the like of the imaging lens 18. If the second curtain 209 is held and the first curtain 210 is opened while the main mirror 20 and the sub-mirror 24 are retracted from the light path, light having passed through the imaging optical system 19 or the like is led to the image sensor 418. By continuously photographing and displaying an image on the monitor unit 417 in this state, the live view image can be displayed. According to the present exemplary embodiment, the main mirror 20 and the sub-mirror 24 are retracted upwardly. The main mirror 20 and the sub-mirror 24, however, may be retracted in any other directions such as a lateral direction.

A focusing state of the imaging lens 18 can be obtained by detecting a contrast of a part (predetermined AF area) of the image sensor 418 during the live view state. The contrasts between a plurality of positions of the imaging lens obtained by driving the imaging lens are compared and focus adjustment can be achieved by driving the photographic lens to reach a position where the contrast is the maximum (AF operation of the contrast system).

In order to perform the AF operation of the contrast system, the main mirror 20 and the sub-mirror 24 should be retracted from the light path where light passes through the imaging optical system 19 or the like of the imaging lens 18 to their up positions 20u and 24u. In this case, the camera can realize the live view state. To the contrary, in order to perform the AF operation of the phase difference system, the main mirror 20 and the sub-mirror 24 should be positioned within the light path to lead the light beam from the subject to the focus detection unit 413. In this case, the live view state is to be paused once. Because of such a configuration, two of those AF systems are not performed concurrently.

FIG. 3 is a block diagram illustrating an exemplary circuit configuration of the digital camera having the above described structure.

In FIG. 3, a microcomputer (CPU) 402 controls the operation of the entire camera including processing of image data output by the image sensor 418 and displaying of the monitor unit 417. SW1 405 is a switch which is activated while the release button 114 is half pressed, and SW2 406 is a switch which is activated while the release button 114 is completely pressed (full press state). When the switch SW1 is turned ON, the digital camera is brought into a shooting preparation state. That is, a light metering operation is started and, at the time of photographing with an optical finder, the AF operation is started. Here, the light metering operation is performed by a light metering unit (not shown). Further, when the switch SW2 is turned ON, the digital camera starts a shooting operation (image capturing and recording). The switches SW1 and SW2 are connected to interrupt ports. If interruption is not prohibited, the digital camera keeps performing predetermined operations, i.e. the light metering operation and the release operation, regardless of a state of the camera.

A switch sensing unit 410 transmits signals of various switches, including the electronic dial 115 and the AF button 113 as illustrated in FIG. 1, to a microcomputer 402. The focus detection unit 413 detects a defocus amount of the imaging optical system 19 with respect to the subject in the AF operation as described above. A lens control unit 407 establishes a communication with the imaging lens 18, drives the imaging optical system 19 while performing the AF operation, and controls driving of diaphragm blades.

The microcomputer 402 calculates a lens drive amount based on the defocus amount detected by the focus detection unit 413 (performs a focus detection), and the lens control unit 407 drives the imaging optical system 19 according to the lens drive amount thus calculated (focus adjustment). In other words, the AF operation is performed.

A mechanism control unit 415 drive-controls the second curtain 209, the first curtain 210, the main mirror 20, and the sub-mirror 24. In the live view state, the main mirror 20 and the sub-mirror 24 are controlled to be positioned at their up positions, respectively, the second curtain 209 is held at its present position, and the first curtain 210 is kept in an open state. Accordingly, the light from the subject is led to the image sensor 418.

The monitor unit 417 constitutes, in combination with a backlight lighting system (not shown), an image display device. The image sensor 418 outputs an analog signal which is then converted into a digital signal by the A/D converter 423 to be temporarily recorded in a buffer memory 424. An image processing unit 425 performs detection of a contrast and provides a color processing such as auto-white balance, intensity, generation of color signals with respect to a pixel signal read out of the buffer memory 424. The color image signals generated by this image processing unit 425 are stored again in the buffer memory 424. The monitor unit 417 displays the color image signal stored in the buffer memory 424 as a color image.

After the microcomputer 402 retracts the main mirror 20 and the sub-mirror 24 out of the light path of the imaging optical system 19, the microcomputer 402 repeats a process of processing the signal output from the image sensor 418 and displaying the image on the monitor unit 417. Accordingly, a display of the live view image (electronic view finder) can be realized.

The microcomputer 402, in the live view state, can perform the focus adjustment by using contrast values of the predetermined partial areas (AF areas) within an image output from the image processing unit 425. The microcomputer 402 calculates the contrast values before driving the imaging optical system, and the lens control unit 407 subsequently drives the imaging optical system 19 by a predetermined amount. The microcomputer 402 calculates a contrast amount output from the image processing unit 425 at a position where the imaging optical system 19 is driven. The microcomputer 402 compares the contrast values between before and after the imaging optical system 19 is driven, to drive the imaging optical system 19 so that the contrast value becomes larger. The microcomputer 402 repeats the driving of the imaging optical system 19 using the lens control unit 407 and the contrast detection using the image processing unit 425 to perform a focus adjustment.

A recording/reproducing process unit 403 records a color image signal having been stored in the buffer memory 424 in a recording medium 404. Thus obtained image is recorded in the recording medium 404 in the release operation, while the obtained image is not recorded in the recording medium 404 in the live view display operation. A typical example of the recording medium 404 is a memory card including a semiconductor memory, for example, a card type flash memory. When reproducing the image recorded in the recording medium 404, the recording/reproducing process unit 403 performs a reproducing process of the image data, temporarily records the image data in the buffer memory 424 in the form of the color image signal, and displays (reproduces) the image on the monitor unit 417.

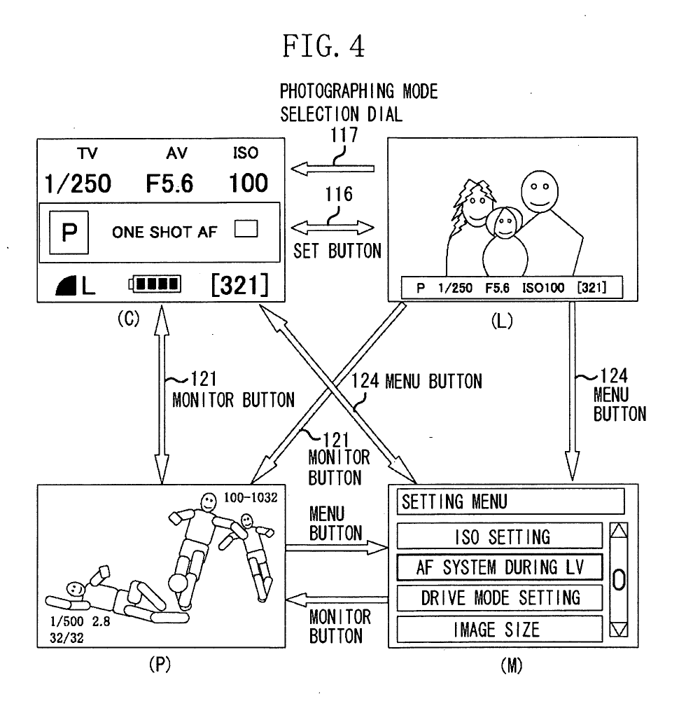

Now, a transitional condition of the digital camera according to the present exemplary embodiment is described below with reference to FIG. 4. The digital camera is switched into four conditions, i.e., a camera state (C), a live view state (L), a reproducing state (P), and a menu displaying state (M).

The camera state (C) is a state capable of photographing a subject by using the optical finder. The monitor unit 417 displays information necessary for photographing, i.e., a TV value (shutter speed), an AV value (aperture value), an ISO sensitivity, a photographing mode, an image size, the number of photographable sheets. When the camera is turned ON and activated, the camera displays the above-described information. Further, when the camera is activated, interruption of the switch SW2 is permitted in synchronization with the full press of the release button 114, and, unless otherwise the interruption is prohibited, the user can perform a shooting operation (image capturing and recording) at any time.

When the switch SW1 is turned ON by half-pressing the release button 114 in the camera state (C), the camera starts the light metering operation and the AF operation from the camera state (C). Then, when the switch SW2 is turned ON, the camera performs the release operation. The AF operation can also be performed by pressing the AF button 113 in the camera state (C).

When the switch SW1 is turned ON in the reproducing state (P) or in the menu displaying state (M), the camera comes out of the each state to come into the camera state (C).

By turning a photographing mode dial 117, the photographing mode is changed while the camera is kept in the camera state (C), and a photographing mode display is updated. Further, in a TV prioritized photographing mode and a manual photographing mode, the TV value can be directly changed by operating the electronic dial 115 illustrated in FIG. 1 (similarly, in an AV prioritized photographing mode, the AV value can be changed).

The camera comes to be in the live view state (L) by pressing the SET button 116 in the camera state (C). Further, the camera comes to be in the menu displaying state (M) and the reproducing state (P), respectively, when the menu button 124 or the monitor button 121 is pressed in the camera state (C).

In the live view state (L), the main mirror 20 and the sub-mirror 24 are retracted out of the light path of the imaging optical system 19, photographing is continuously performed with the shutter full open, and an image (live view image) is displayed on the monitor unit 417. Photographing information (TV value, AV value, ISO sensitivity, etc.) is displayed overlapping with the live view image. The camera state (C) is switched to the live view state (L) by pressing the SET button 116.

In the TV prioritized photographing mode and the manual photographing mode, by operating the electronic dial 115, the TV value can be changed while the live view state (L) is kept (In the AV prioritized photographing mode, the AV value can be changed.).

When the AF button 113 is pressed in the live view state (L), the main mirror 20 and the sub-mirror 24 are positioned within the light path of the imaging optical system 19 to perform the AF operation. Since the image sensor 418 is shielded, the live view is not displayed on the monitor unit 417.

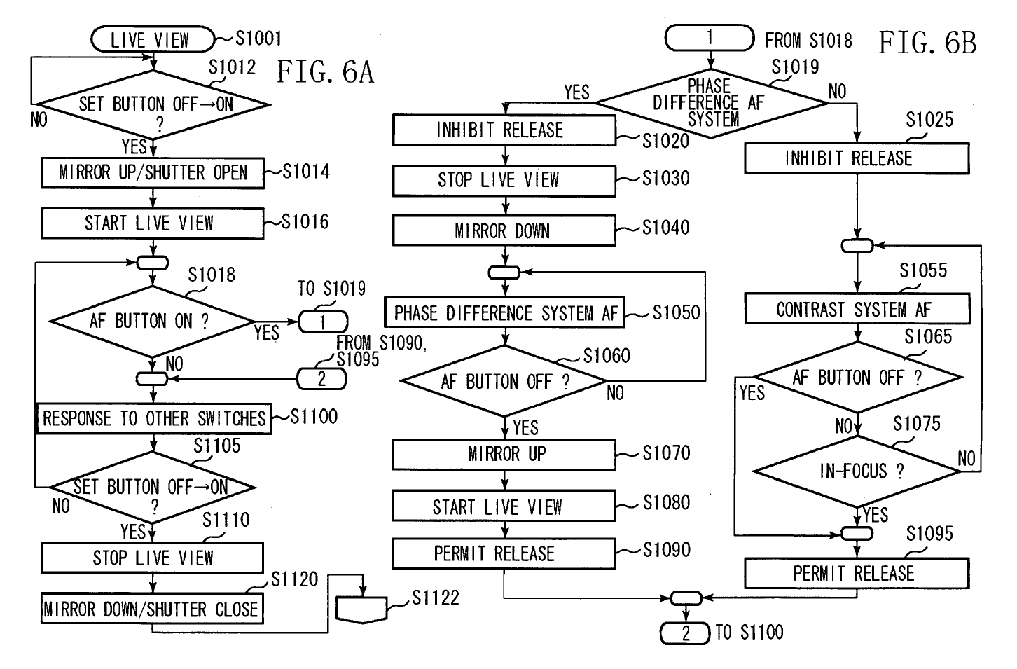

When the switch SW1 is turned ON in the live view state (L), the metering operation starts. The metering operation in the live view state is performed using an output signal of the image sensor 418. The live view state continues even when the switch SW1 is turned ON, namely, the live view state is not switched to the camera state (C). Then, when the switch SW2 is turned ON, the release operation is performed (except for a case where the release operation is prohibited). A possible action involved in the AF operation in the live view state is described below in detail with reference to FIGS. 6A and 6B.

When the menu button 124 is pressed in the live view state (L), the live view state is ended and switched to the menu displaying state (M). The state will not return to the live view state (L) even when the menu displaying state (M) is ended. Further, when the monitor button 121 is pressed in the live view state (L), the live view state is ended and switched to reproducing state (P). The state will not return to the live view state (L) even when the reproducing state (P) is ended.

When the photographing mode dial 117 is turned to change the photographing mode, the live view state (L) is ended and switched to the camera state (C). When the SET button 116 is pressed, the live view state is ended and switched to the camera sate (C). The camera state (C) and the live view state (L) are switched to each other by pressing the SET button 116.

In the reproducing state (P), a photographed image is reproduced and displayed. When the monitor button 121 is pressed in the camera state (C), the live view state (L), or the menu displaying state (M), the state is switched to the reproducing state (P), respectively. When the menu button 124 is pressed in the reproducing state (P), the state is switched to the menu displaying state (M). When the monitor button 121 is pressed and the switch SW1 is turned ON in the reproducing state (P), the state is switched to the camera state (C). When the photographing mode dial 117 is changed in the reproducing state (P), the state is switched to the camera state (C) and the photographing mode is changed. The state is not directly switched from the reproducing state (P) to the live view state (L) even when the SET button 116 is pressed.

In the menu displaying state (M), a list of setting items can be displayed to make various camera settings (the setting is performed by displaying a sub-screen (option screen) for each setting item). When the menu button 124 is pressed in the camera state (C), the live view state (L), or the reproducing state (P), the state returns to a TOP screen, namely, the menu displaying state (M).

When the switch SW1 is turned ON in the menu displaying state (M), the state is switched to the camera state (C). When the monitor button 121 is pressed in the menu displaying state (M), the state is switched to the reproducing state (P). When the menu button 124 is pressed in the menu displaying state (M) of the TOP screen, the state is switched to the camera state (C). When the menu button 124 is pressed in the menu displaying state (M) of a sub-P screen, the state is returned to a screen at the next upper level. When the photographing mode dial 117 is changed in the menu displaying state (M), the state is switched to the camera state (C), and the photographing mode is changed. When the SET button 116 is pressed in the menu displaying state (M), the menu displaying state (M) is changed to a setting of the selected item (or a setting screen display) but is not switched to the live view state (L).

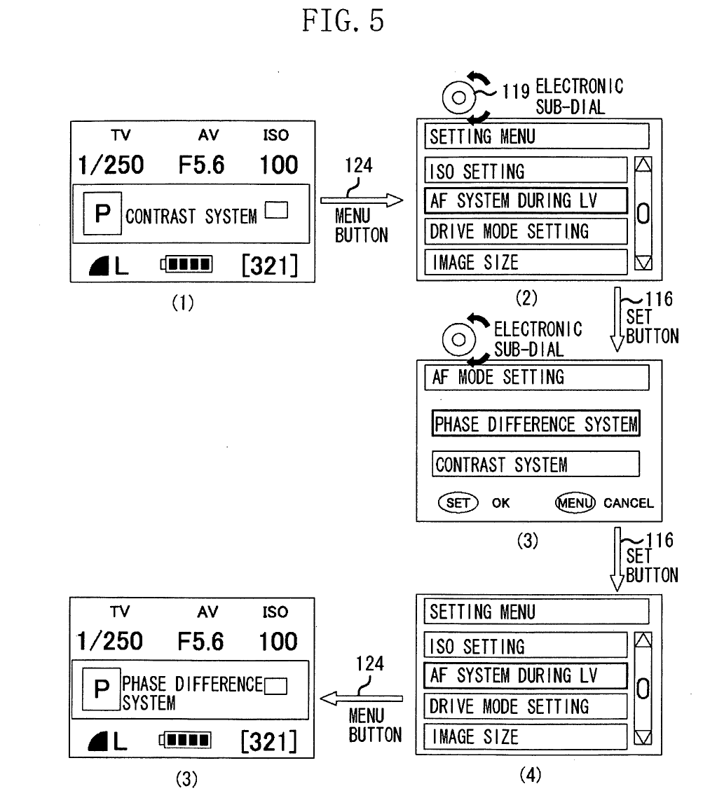

An exemplary setting of the AF system in the menu screen during the LV is described below with reference to FIG. 5.

When the menu button 124 is pressed in the camera state (C) of FIG. 4 (see FIG. 5(1)), the camera state (C) is switched to the menu displaying state (M) of FIG. 4 and a setting menu (TOP screen) is displayed (see FIG. 5(2)). In this state, the user operates the electronic sub-dial 119 to select an “AF system setting during the LV” among the items of the setting menu. Then, when the SET button 116 is pressed, the screen is changed to a screen in which an AF system during the LV is set (see FIG. 5(3)). The AF system during the LV includes at least two kinds of systems such as the above described phase difference system and contrast system. The AF systems can be selected with the electronic sub-dial 119. In the phase difference system, at least a portion of the light beam from the imaging lens is divided to be led to the focus detection unit to adjust a focus of the photographic lens. Therefore, light is not led to the image sensor 418 while the AF operation is performed, and display of the live view image is discontinued.

In the AF operation of the contrast system, a contrast of an image is detected by the image processing unit 425 based on an image signal of the live view image and thereby a focus of the photographic lens is adjusted. Therefore, the live view image is continuously displayed in this contrast system.

Since these two AF systems cannot be concurrently operated because of the configuration of the camera, either one of the systems is to be selected from the MENU screen in advance.

When the SET button 116 is pressed in a state that the AF system during the LV which the user desires, is selected (for example, the phase difference system), the AF system during the LV is set (the AF system becomes the phase difference system). When the setting is ended, the screen returns to the setting menu (see FIG. 5(4)). Further, when the menu button 124 is pressed, the state returns to the camera state (see FIG. 5 (5)).

Further, when an initial state is the live view state (L), the AF system during the LV can similarly be set.

Now, an operation as to the live view is described below in view of an entire sequence of the digital camera with reference to flow charts of FIGS. 6A and 6B. In these flow charts, actions involved in the AF operation during a normal sequence in the live view state are described. Special kinds of actions or methods for fixing unintentional errors are not described in the charts.

The flow chart starts with display of the live view following the camera state (C) of FIG. 4.

In step S1001, the microcomputer 402 starts the operation. Then, in step S1012, the microcomputer 402 waits until the SET button 116 is turned ON (pressed). When the microcomputer 402 determines that the SET button 116 is turned ON (if YES in step S1012), the process proceeds to step S1014 where the microcomputer 402 controls the mechanism control unit 415 to drive the main mirror 20 and the sub-mirror 24 to their up positions, respectively (positions of 20u and 24u of FIG. 2). Further, the microcomputer 402 causes the first curtain 210 to travel to open the shutter.

In the next step S1016, the microcomputer 402 performs continuous photographing while the photographing light beam is led to the image sensor 418 and displays the live view image on the monitor unit 417. Detailed descriptions of control of accumulated time and a frame rate during the live view state, and gain control at the time of reading out are omitted here.

In step S1018, the microcomputer 402 determines whether the AF button 113 is turned ON to bring the camera into the live view state. If the AF button 113 is ON (if YES in step S1018), the process proceeds to step S1019, where the microcomputer 402 starts the AF operation during the LV as described below. If the AF button is not ON (if No in step S1018), the process proceeds to step S1100 while the AF operation is skipped.

When the AF button 113 is turned ON (if YES in step S1018) and the process proceeds to step S1019, the microcomputer 402 initially performs determination of the AF system during the LV.

Here, the step branches depending on the preliminary set AF system, i.e., depending on whether the preliminary set AF system is the phase difference system or the contrast system. If the AF system is the phase difference system (if YES in step S1019), the process proceeds to step S1020. Before the AF button 113 is turned ON, the AF system during the LV is determined according to the method as described in the menu displaying state (M) of FIG. 4 and FIG. 5.

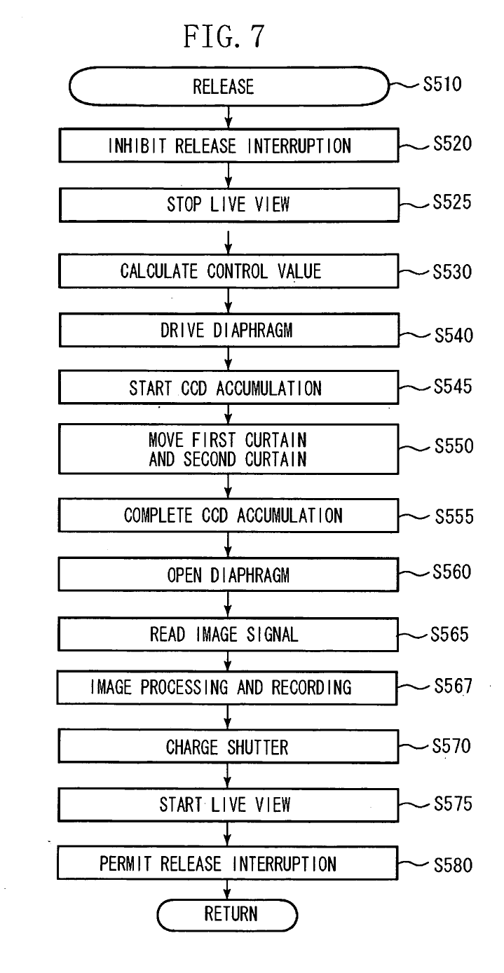

In step S1020, the microcomputer 402 prohibits a release operation. More specifically, the microcomputer 402 prohibits interruption of the switch SW2 which is turned ON by a full press of the release button 114, thereby prohibiting the shooting operation (release operation) of an image. The switch SW2 is connected to the microcomputer 402, so that the interruption of the switch SW2 is permitted after the camera is completely activated. Then, when the switch SW2 is turned ON in a state where the interruption is permitted, a “release” sub-routine, which will be described later with reference to FIG. 7, is executed to allow the shooting operation of the image.

In the next step S1030, since light is not led to the image sensor 418 while the coming AF operation of the phase difference system is in operation, the microcomputer 402 stops displaying the live view. Then, the microcomputer 402 moves the main mirror 20 and the sub-mirror 24 to their down positions, respectively, in order to perform focus detection. In the present exemplary embodiment, the sub-mirror 24 moves in synchronization with the main mirror 20 to the position allowing focus detection; however, the sub-mirror may independently move to the position allowing the focus detection. Further, the present exemplary embodiment may be so configured that the light beam is led to the focus detection unit 413 by using the main mirror 20 but without using the sub-mirror 24. In any way, a portion or the entirety of the light beam led to the image sensor 418 is to be shielded in order to perform the focus detection. Then, the shutter is also closed.

In the next step S1050, the microcomputer 402 detects a defocus amount of the subject by the AF operation of the phase difference system performed by the focus detection unit 413. Then, the microcomputer 402 calculates a lens drive amount based on thus detected defocus amount in a predetermined manner and outputs thus calculated lens drive amount to the lens control unit 407. Accordingly, the lens control unit 407 drive-controls the imaging optical system 19 by the calculated lens drive amount. In other words, the AF operation of the phase difference system is performed in this step.

In step S1060, the microcomputer 402 determines if the AF button 113 is turned OFF. If the AF button 113 is not OFF (if No in step S1060), the process returns to step S1050, and the microcomputer 402 performs the AF operation of the phase difference system. In other words, the microcomputer 402 executes the AF operation in which the operations of the defocus detection, the calculation of the lens drive amount, and the lens driving are repeated while the AF button 113 is ON.

Then, when the AF button 113 is turned OFF (if YES in step S1060), the process proceeds to step S1070. In step S1070, the microcomputer 402 drives the main mirror 20 and the sub-mirror 24 to their up positions, respectively, (positions 20u, 24u of FIG. 2), and further, causes the first curtain 210 to travel to place the shutter in an open state.

In step S1080, the microcomputer 402 continuously performs the shooting operation of the image sensor 418 and displaying of thus photographed image on the monitor unit 417 and restarts the live view display. Here, by viewing the live view display, a state (framing) of the subject or a focusing state can be confirmed.

In step S1090, the microcomputer 402 cancels the prohibited state of the release interruption determined in step S1020 and permits the switch SW2 to interrupt, thereby permitting a recording operation (release operation) of an image. Consequently, if the release button 114 is fully pressed after the above step, interruption of the “release” sub-routine is performed, thereby enabling the recording operation of the image.

In the case where the AF system during the LV is the phase difference system (if YES in step S1019) as described above, if the AF button 113 is operated (turned ON) in the live view state, the microcomputer 402 prohibits the release operation and stops displaying the live view to perform the AF operation (S1020→S1030→S1040→S1050). Then, after the operation of the AF button 113 is stopped (turned OFF), the microcomputer 402 restarts to display the live view as well as permits the release interruption operation (S1060→S1070→S1080→S1090). Accordingly, unintentional photographing can be prevented during the AF operation in a state that the live view image is not viewable.

In the case that the AF system in step S1019 is the contrast system (if NO in step S1019), the process proceeds to step S1025. In step S1025, the microcomputer 402 initially prohibits the release operation (the operation is similar to the one performed at step S1020). In a state that the interruption is prohibited, the release sub-routine (FIG. 7) is not executed even if the switch SW2 is turned ON, and therefore, the shooting operation is not performed. In step S1055, the microcomputer 402 performs the focus detection by using the contrast value output from the image processing unit 425. After the contrast value is detected, the microcomputer 402 outputs a predetermined lens drive amount to the lens control unit 407. The microcomputer 402 obtains the contrast value from the image processing unit 425 after the end of the lens drive. The microcomputer 402 compares contrast values before and after driving the lens and calculates the next lens drive amount so that the contrast value becomes larger. The lens control unit 407 drive-controls the imaging optical system 19 by thus calculated lens drive amount.

In step S1065, the microcomputer 402 determines if the AF button 113 is turned OFF. If the AF button 113 is OFF (if YES in step S1065), the process proceeds to step S1095. If the AF button 113 is not OFF (if NO in step S1065), the process proceeds to step S1075.

In step S1075, the microcomputer 402 determines if the result of the focus detection shows the in-focus point. If the result does not show the in-focus point (if NO in step S1075), the process returns to step S1055 where the microcomputer 402 performs the AF operation of the contrast system. In other words, the microcomputer 402 performs the AF operation (focus adjustment) of the contrast system by repeating step S1055, step S1065, and step S1075 in this order.

If the microcomputer 402 determines that the result of the focus detection in step S1075 shows the in-focus point (if YES in step S1075), the process proceeds to step S1095, and the microcomputer 402 comes out of the repetition of the AF operation of the contrast system.

In the next step S1095, the microcomputer 402 cancels the prohibition of the release interruption operation prohibited in the above step S1025 to permit the interruption of the switch SW2, thereby permitting the recording operation (release operation) of the image. In the case where the microcomputer 402 determines that the result of the focus detection shows the in-focus point in step S1075 (if YES in step S1075) and goes to step S1095, the release operation is permitted even if the AF button 113 is kept ON. Therefore, if the release button 114 is thereafter fully pressed, the interruption of the “release” sub-routine is performed, and therefore the recording operation of the image becomes possible.

Similarly, in the case where the AF button 113 is turned OFF in step S1065 (if YES in step S1065), the release operation is permitted in step S1095, and therefore, the recording operation of the image becomes possible.

As described above, in the case where the AF system during the LV is the contrast system, if the AF button 113 is operated (turned ON) in the live view state, the microcomputer 402 performs the AF operation while keeping the live view display state (S1025→S1055). Then, the microcomputer 402 repeats the AF operation until the in-focus point is obtained. If the operation of the AF button 113 is ended (turned OFF) in the way of repetition of the AF operation, the microcomputer 402 ends the AF operation (S1055→S1065→S1075). The microcomputer 402 prohibits the release operation until the in-focus point is obtained; however, it permits the release interruption after obtaining the in-focus point (S1075→S1095). As a result, the photographing can be performed immediately after the in-focus point is obtained.

In the case of the AF operation of the contrast system, prohibition of the release operation until obtaining the in-focus point is not necessarily required since the subject can be confirmed by the display of the live view during the AF operation.

In the present exemplary embodiment, the AF system during the LV is the phase difference system or the contrast system; however, the AF system is not limited to those systems. The present invention is applicable to any AF system which can be performed while the live view display is stopped and any AF system which can be performed while the live view is continuously displayed.

More specifically, in the case of the AF system performed while the live view display is stopped, the release operation is prohibited while the AF button is operated, whereas, in the case of the AF system performed while the live view is continuously displayed, the release operation is permitted even while the AF button is operated.

After the above described series of AF operations are ended, or in the case where the AF button 113 was not operated in step S1018 (if NO in step S1018), the process proceeds to step S1100 where the microcomputer 402 performs a processing in response to the other switch operation. For example, the microcomputer 402 performs changing of a setting value by the electronic dial 115 or switching of a display style of the live view (switch therefore is not shown). Further, depending on a kind of the switch, the microcomputer 402 performs an operation in response to the switch (menu button 124, monitor button 121, or the like) after ending the live view state.

Then, the process proceeds to step S1105, where the microcomputer 402 determines whether the SET button 116 is turned ON. If the SET button 116 is not ON (if NO in step S1105), the microcomputer 402 continues the live view state and the process returns to step S1018 to repeat operations with respect to the AF button 113 and the other switches.

In step S1105, if the microcomputer 402 determines that the SET button 116 is turned ON (if YES in step S1105), the process proceeds to step S1110. In step S1110, the microcomputer 402 stops the operation of the image sensor 418 and displaying of the monitor unit 417, and ends the live view state. In step S1120, the microcomputer 402 controls the mechanism control unit 415, and drives the main mirror 20 and the sub-mirror 24 to their down positions, respectively. Further, the microcomputer 402 charges the shutter and places the image sensor 418 in a shielded state. Finally, in step S1122, the state returns to the camera state (C) of FIG. 4.

Now, the operation of the “release” sub-routine from the live view state is described below with reference to the flow chart of FIG. 7. This operation is executed by an interruption routine.

Initially, the switch SW2 is turned ON by fully pressing the release button 114 while the release interruption operation is permitted. The “release” sub-routine is called by the release interruption processing, and the microcomputer 402 starts operations from step S520 via step S510. In step S520, the microcomputer 402 prohibits the release interruption operation. Then, in step S525, the microcomputer 402 ends the live view operation in order to take a still image. The microcomputer 402 charges the shutter and moves the first curtain 210 to a position before it travels.

In step S530, the microcomputer 402 calculates a diaphragm value and a shutter speed. The diaphragm value and the shutter speed can be calculated using a predetermined algorithm based on the photographing mode, the light metering value, or the setting value of the camera. In the case where the diaphragm value and the shutter speed are set in advance, it is not required to calculate them here. In step S540, the microcomputer 402 performs control to set a diaphragm provided within the imaging lens 18 to a value calculated in step S530 with the lens control unit 407. In the case of the live view photographing, the main mirror 20 and the sub-mirror 24 are already positioned at their up positions, respectively, so that it is not required here to drive mirrors.

In step S545, the microcomputer 402 starts charge accumulation (CCD accumulation) of the image sensor 418. Then, in step S550, the microcomputer 402 starts an exposing process by causing the shutter control unit 415 to move the first curtain 210. Subsequently, the microcomputer 402 ends the exposure process by moving the second curtain 209 after a predetermined time period calculated in step S530. In step S555, the microcomputer 402 ends the charge accumulation (CCD accumulation) of the image sensor 418 after the end of the movement of the second curtain 209.

In step S560, the microcomputer 402 causes the lens control unit 415 to perform control to open the diaphragm provided within the imaging lens 18. Then, in step S565, the microcomputer 402 reads an image signal from the image sensor 418 and temporarily records the image data in the buffer memory 424 after the image data is processed by the A/D converter 423 and the image processing unit 425. In step S567, the microcomputer 402 converts the image signal read from the buffer memory 424 into a color image signal by the image processing unit 425 to record the color image signal in the recording medium 404 using the recording/reproducing process unit 403.

In step S570, the microcomputer 402 charges the shutter and drives the first curtain 210 and the second curtain 209 to the positions before they are moved, respectively. Then, in step S575, the microcomputer 402 restarts the live view operation of the image sensor 418. In step S580, the microcomputer 402 permits the release interruption operation.

With the above proceeding, a series of the release operations is ended.

In the flow chart of FIG. 7, the release operation is performed in the live view state (L); however, the operation is almost the same in the case where the release operation is performed in the camera state (C). More specifically, it becomes unnecessary to stop/start the live view operation in steps S525 and S575, but, instead of that processing, it becomes necessary to drive mirrors (up/down operation) in steps S540 and S570.

As described above, according to the present exemplary embodiment, if the AF button 113 is turned ON when the AF operation of the phase difference system is performed in the live view state, the live view display state is stopped and the release operation is prohibited in order to perform the AF operation of the phase difference system. If the AF button 113 is turned OFF, the live view display state is restarted and the release interruption operation is permitted. Accordingly, unintentional photographing during the AF operation is prevented.

In the case where the AF operation of the contrast system is performed in the live view state, if the AF button 113 is turned ON, the live view display state is continued while the AF operation of the contrast system is performed. The release operation can be performed even while the AF button 113 is ON. Therefore, the user can take a picture while he confirms the displayed live view screen.

In the present exemplary embodiment, for example, the switch SW1 of the release button 114, instead of the AF button 113, may be used for starting the auto-focusing operation from the live view state, provided that the user gives up operability. Here, in the case where the user attempts to record an image in the recording medium 404, the user once turns off the switch SW1 of the release button 114 in the case of the AF operation of the phase difference system. Then, the user turns ON the switch SW2 of the release button 114 in a breath. On the other hand, the above described operation of turning off once becomes unnecessary in the case of the contrast system. Namely, the state can be switched directly from the ON state of the switch SW1 of the release button 114 to the ON state of the switch SW 2 of the release button 114.

The present invention is applicable to an imaging apparatus of a digital camera capable of providing a live view display, more specifically, an imaging apparatus of a digital single lens reflex camera, which has a live view function for confirming an image before photographing it and is suitable for performing a focus adjustment during a live view operation.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-011629 filed Jan. 22, 2008, which is hereby incorporated by reference herein in its entirety.

What is claimed is:

1. An imaging apparatus comprising:
a monitor configured to display an image generated based on a signal from a sensor which photoelectrically converts an object image;
a first auto-focus unit configured to perform a first auto-focusing operation based on a phase difference of the object image according to an operation of a first switch by a user;
a light path switching unit configured to lead light having passed through an imaging optical system to the first auto-focusing unit;
a live view controller configured to retract the light path switching unit from a light path of the imaging optical system to the sensor, and display an image from the sensor on the monitor;
a second auto-focus unit configured to perform a second auto-focusing operation based on a high-frequency component of the signal from the sensor in response to an operation of the first switch by the user;
a second switch configured to record the image from the sensor in a recording medium; and
an image recording controller configured to prohibit recording of the image in the recording medium according to the operation of the second switch while the first auto-focusing operation is performed, and permit recording of the image in the recording medium according to the operation of the second switch while the second auto-focusing operation is performed.

2. The imaging apparatus according to claim 1, wherein the image recording controller repeats the first auto-focusing operation until the image recording controller obtains an in-focus point signal, and, if the first auto-focusing operation is prohibited after the in-focus point signal is obtained, the image recording controller prohibits recording of the image according to the operation of the second switch.

3. The imaging apparatus according to claim 1, wherein the image recording controller permits recording of the image according to the operation of the second switch by the operation of the first switch being stopped, in the case where the image recording controller repeats the first auto-focusing operation while the first switch is in operation.

4. The imaging apparatus according to claim 1, wherein the image recording controller prohibits recording of the image according to the operation of the second switch until the image recording controller determines that an in-focus point is obtained and permits recording of the image according to the operation of the second switch after the image recording controller determines that the in-focus point is obtained, when the second auto-focusing operation is performed.

5. A method of controlling an imaging apparatus including a monitor configured to display an image generated based on a signal from a sensor which photoelectrically converts an object image, a first auto-focusing unit configured to perform a first auto-focusing operation based on a phase difference of the object image in response to an operation of a first switch by a user, a light path switching unit configured to lead light having passed through an imaging optical system to the first auto-focusing unit, a live view controller configured to retract the light path switching unit from a light path of the imaging optical system to the sensor and display the image from the sensor on the monitor, and a second auto-focusing unit configured to perform a second auto-focusing operation based on a high frequency component of the signal from the sensor in response to the operation of the first switch by the user, the method comprising:
recording the image from the sensor in a recording medium in response to the operation of a second switch by the user;
prohibiting recording of the image in the recording medium in response to the operation of the second switch while the first auto-focusing operation is performed; and
permitting recording of the image in the recording medium in response to the operation of the second switch while the second auto-focusing operation is performed.
